(19) United States
(12) Patent Application Publication
(10) Pub. No.: US 2018/0093711 A1
(43) Pub. Date: Apr. 5, 2018

(54) VEHICLE HOOD SUPPORT FOR ACCOMMODATING FRONT LOADED COMPONENTS DURING INSTALLATION AND RELATED METHODS

(71) Applicant: FORD GLOBAL TECHNOLOGIES, LLC, Dearborn, MI (US)

(72) Inventor: Daniel Alejandro Arguello Gleason, Coyoacan (MX)

(21) Appl. No.: 15/281,763

(22) Filed: Sep. 30, 2016

(51) Int. Cl. B62D 25/12

(52) U.S. Cl. CPC B62D 25/12

(57) ABSTRACT

An apparatus for providing reliable support for a part of a vehicle, such as the hood, above a bolster is provided. The apparatus includes a support for supporting the vehicle hood. The support comprises a spacer and a clip for connecting the spacer to the bolster, which can be installed on the bolster easily and quickly once the front end component is loaded. Related methods are also disclosed.

### TECHNICAL FIELD

This document relates generally to the motor vehicle field and, more particularly, to a vehicle hood support for accommodating the installation of front loaded components and related methods.

### BACKGROUND

Motor vehicles, such as passenger cars, may be designed to allow for components, such as the headlamp, to be loaded from the front during the assembly process. However, the front loading operation may be made difficult by the need to provide for a support of a sufficient height to provide adequate support for the vehicle hood when closed, which support can serve as an obstacle that hampers the installation process. Reducing the height of the hood support is not a viable option, since this would lead to misalignment relative to the fixed position of the hood and resulting noise, such as may be caused by rattling of the hood in the space created by the resulting gap.

Thus, a need is identified for a vehicle hood support that can accommodate the efficient installation of a front loaded component without compromising the desirable stable support for the vehicle hood.

### SUMMARY

In accordance with the purposes and benefits described herein, an apparatus for providing reliable support for vehicle hood above a bolster is provided. The apparatus comprises a support for supporting the vehicle hood. The support includes a spacer and a clip for connecting the spacer to the bolster.

In one embodiment, the spacer includes an oversized head and a depending portion for engaging the clip. The clip may comprise a recess for receiving and retaining the depending portion of the spacer. The clip may be U-shaped so as to provide the recess for receiving the depending portion of the spacer, which may comprise an injection molded plastic material.

The disclosure may also relate to a vehicle including the apparatus. The vehicle may include a front end component adapted to pass over the bolster prior to installation of the support. The support may then be installed for supporting the hood when closed.

According to a further aspect of the disclosure, a vehicle comprises a part or component and a bolster for supporting the component. A spacer is provided for spacing the bolster from the vehicle hood, as is a clip for connecting the spacer to the bolster. An intermediate panel (for example a beauty cover) may be positioned between a part of the component (such as a hood bumper in the case of a vehicle hood) and the spacer. The intermediate panel may include an upper surface engaging the bumper and a lower surface engaging the spacer.

The vehicle may further include a front end component having a portion adapted for passing over the bolster during installation. The spacer may extend above the bolster a first vertical distance equal to or greater than a vertical clearance between the portion of the front end component and the bolster. In one embodiment, the front end component comprises a headlamp assembly and the portion comprises a mounting tab.

A further aspect of the disclosure pertains to a method of installing a front end component on a vehicle. The method comprises passing the front end component at least partially through a space above a bolster for supporting a hood of the vehicle, and providing a spacer on the bolster to occupy the space. The method further comprises connecting the spacer to the bolster, such as by clipping the spacer to the bolster. The method may further include the step of providing an intermediate panel for engaging a bumper associated with the hood on an upper surface thereof and the spacer on a lower surface thereof. The method may also involve providing the spacer at a fixed height relative to the bolster. The front end component may comprise a mounting tab, and the passing step comprises passing the mounting tab through the space prior to providing the spacer.

In the following description, there are shown and described several preferred embodiments of a vehicle hood support for accommodating front loaded components. As it should be realized, the arrangement is capable of other, different embodiments and its several details are capable of modification in various, obvious aspects all without departing from the stopper for protecting against headlamp damage, as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the vehicle hood support for accommodating front loaded components and, together with the description, serve to explain certain principles thereof. In the drawing figures:

FIG. 1 is a front perspective view of a motor vehicle front end including a headlamp assembly being installed in a rearward direction using an existing arrangement;

FIG. 2 is a front perspective view showing the continued movement of the headlamp assembly toward an installed position;

FIGS. 3 and 4 are partially cross sectional side views of the hood support on the existing arrangement;

FIG. 5 is a front perspective view of the vehicle hood support including a spacer;

FIG. 6 is an exploded view of the spacer and an associated clip for securing it to the bolster for supporting the vehicle hood;

FIG. 7 is a side elevational view of the spacer and clip installed on the bolster;

FIG. 8 is a front perspective view a motor vehicle front end including a headlamp assembly being installed in a rearward direction with a reduced height bolster;

FIG. 9 is a partially cross sectional side elevational view of the resulting clearance provided;

FIG. 10 is the motor vehicle front end with the hood in a lowered position and having a bumper contacting an intermediate panel supported by the spacer; and

FIG. 11 is a partially cross-sectional side view of the FIG. 11 arrangement.

Reference will now be made in detail to the present preferred embodiments of the vehicle hood support for accommodating front loaded components and related methods, examples of which are illustrated in the accompanying drawing figures.

### DETAILED DESCRIPTION

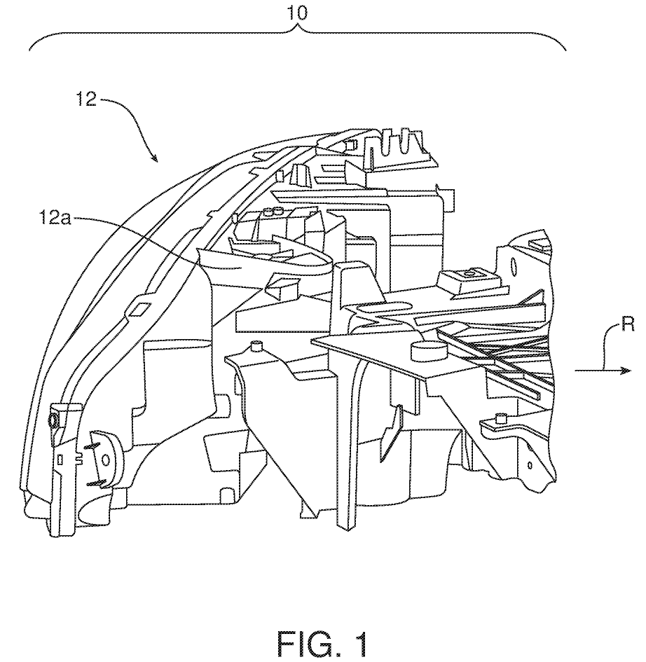

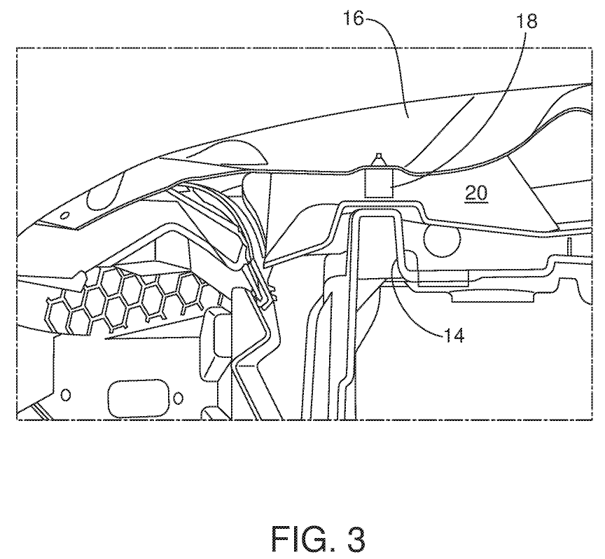

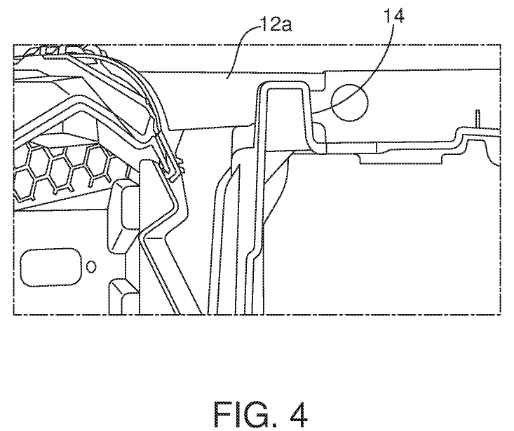

Reference is now made to FIGS. 1-4, which illustrate a vehicle front end 10 including a front loaded component in the form of a headlamp assembly 12. In the existing approach, the headlamp assembly 12 includes a projecting tab 12a that must clear a support, such as a bolster 14 for supporting the vehicle hood 16 (which may including a bumper 18 for engaging an intermediate panel 20, or “beauty” cover, sandwiched between these components). As can perhaps be best appreciated from FIG. 4, the height of the tab 12a may be greater than the height of the support or bolster 14, which serves as a significant obstacle to the installation of the headlamp assembly 12 by moving it purely in a horizontal plane in a rearward direction R.

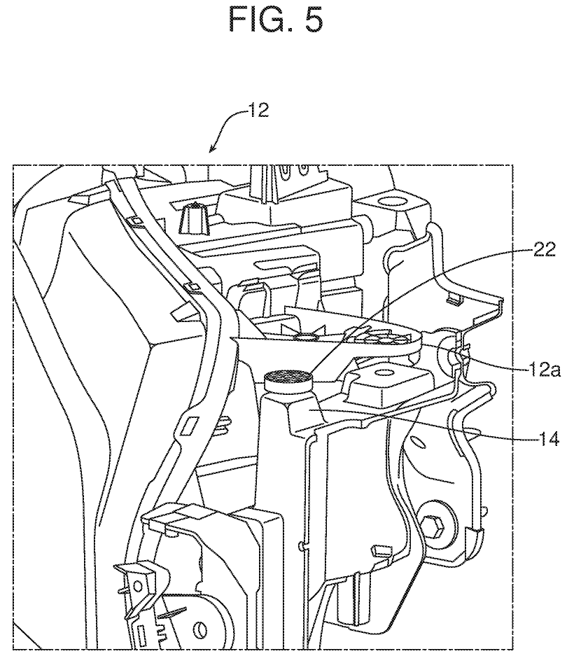

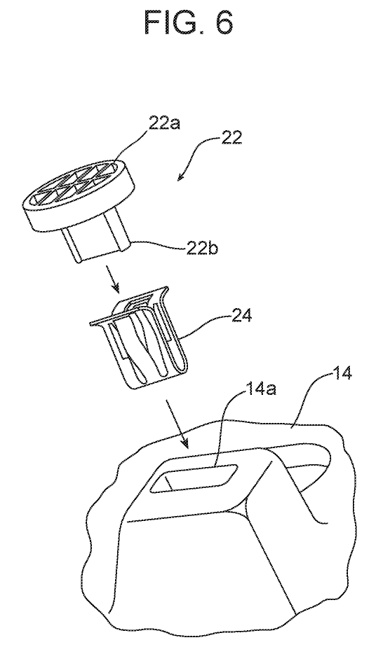

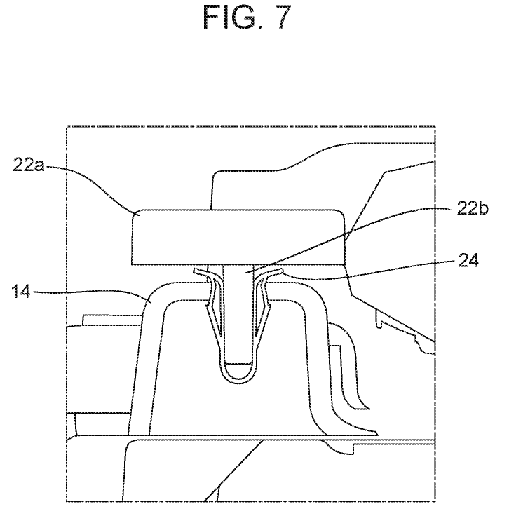

In order to accommodate such front end loading, the bolster 14 may be adapted for receiving a mountable spacer 22, as indicated in FIG. 5. As perhaps best understood with reference to FIGS. 6 and 7, the spacer 22 may be adapted to be secured within an aperture 14a formed in the bolster 14, such as along an upper horizontal surface thereof. The spacer 22 may include an oversized head 22a relative to a depending portion 22b, which head may be sized and shaped to fit within a cavity 20a in the panel 20. Consequently, solid contact surfaces are provided, which may eliminate the potential for fractures or rattling as a result of misalignment, and also assures that all energy from the hood movement is transferred to the bolster 14.

The depending portion 22b may be adapted to be associated with a retention clip 24, such as by being positioned in a generally U-shaped recess formed therein. The clip 24 may include teeth or like inner projections for gripping the depending portion of the spacer 22. This clip 24 may be biased on insertion into the aperture 14a to apply constant pressure to hold the spacer 22 in place. The clip 24 and spacer 22 may be pre-assembled to enhance the efficiency of the installation process.

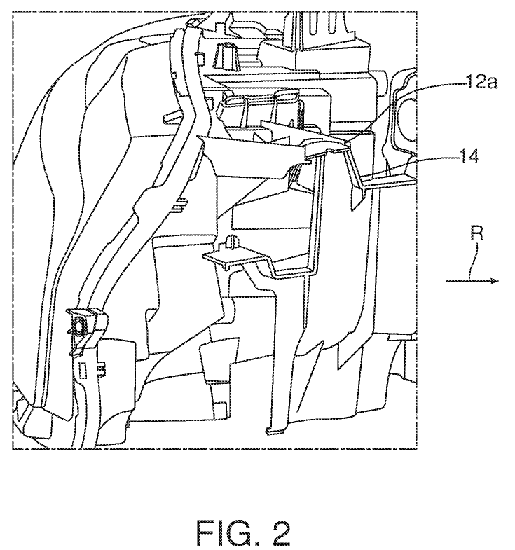

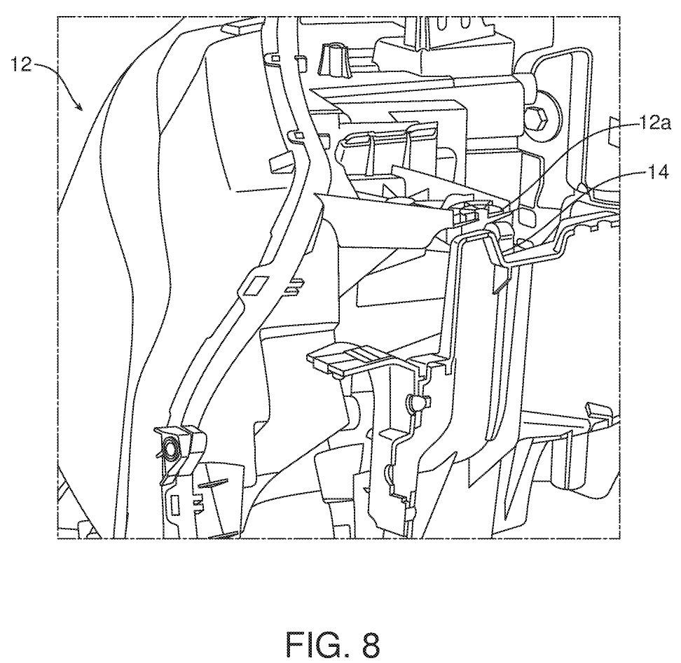

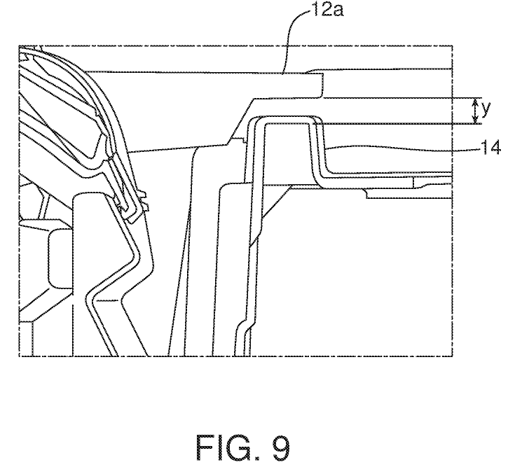

Thus, with reference to FIGS. 8-11, the nature of the improvement provided as a result of the spacer 22 can be fully appreciated. Prior to installation of the spacer 22, a front loaded component such as headlight assembly 12 may be easily pass over the reduced height bolster 14 (note clearance distance Y in FIG. 9, and compare with FIG. 2). The component may then be installed in the desired final position.

Turning back to FIGS. 5-7, once this front end loading operation is complete, the spacer 22 may be installed on bolster 14, such as by inserting the clip 24 associated with the spacer into the bolster opening 14a. The insertion may be completed by pressing the clip 24 and spacer 22 into the opening 14a until the assembly is securely retained.

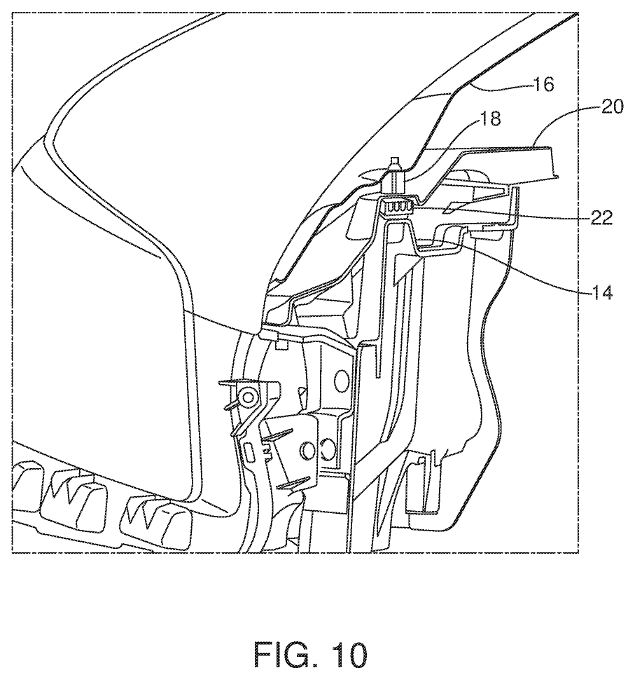

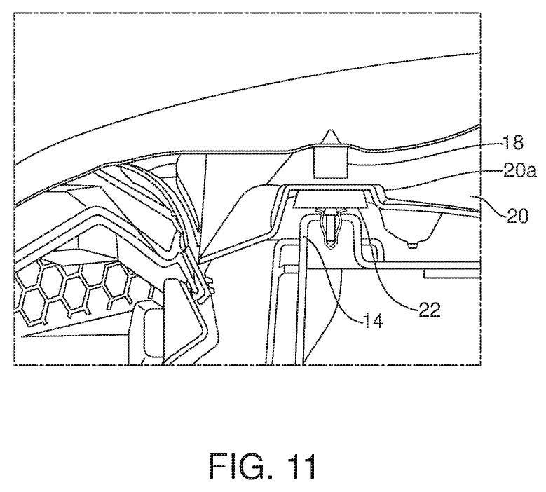

As can be appreciated, the portion of the spacer 22 projecting above the bolster 14 has a dimension greater than a clearance distance between the passing portion of the front end component (e.g., transverse mounting tab 12a of headlamp assembly 12) and the upper surface of the bolster. Thus, with reference to FIGS. 10 and 11, when the intermediate or beauty panel 20 is installed, it may contact and be supported by spacer 22 at the appropriate height for engaging the hood bumper 18, and thus provide reliable, even support for the hood 16 without interfering with the prior installation step for the front end loaded component.

The spacer 22 may be fabricated using a molding technique, such as by injection molding from a lightweight, durable plastic material. Accordingly, the height of the spacer 22 may be precisely controlled to ensure that the reliable, even support for the hood 16 is provided. Given the fixed nature of the height, the installation can be done in as little as one second without compromising the reliability of the resulting support for the vehicle hood 16. No weight impact is created, either. Furthermore, the spacer 22 may be applied symmetrically to the left or right hand side of the vehicle (or other locations) without modification.

In summary, numerous benefits are provided by providing a vehicle front end 10 with a hood support for accommodating front loaded components. The support and, in particular, a bolster 14, may be designed to provide sufficient clearance for the front loaded component to pass into a mounted position. Installation of a spacer 22 then assures that reliable support is provided for the hood 16, such as by way of a bumper 18 for engaging an intermediate beauty panel 20. The arrangement can be inexpensively manufactured and installed at virtually no added cost or time over the existing approach, and yet significantly eases the front end installation process.

The foregoing has been presented for purposes of illustration and description. It is not intended to be exhaustive or to limit the embodiments to the precise form disclosed. Obvious modifications and variations are possible in light of the above teachings. For instance, it should be appreciated that the spacer 22 may be used in connection with components other than the vehicle hood 16. All such modifications and variations are within the scope of the appended claims when interpreted in accordance with the breadth to which they are fairly, legally and equitably entitled.

What is claimed:

1. An apparatus for providing reliable support for vehicle hood above a bolster, comprising:
a support for supporting the vehicle hood, the support comprising a spacer and a clip for connecting the spacer to the bolster.

2. The apparatus of claim 1, wherein the spacer includes an oversized head and a depending portion for engaging the clip.

3. The apparatus of claim 2, wherein the clip comprises a recess for receiving and retaining the depending portion of the spacer.

4. The apparatus of claim 1, wherein the clip is U-shaped.

5. The apparatus of claim 1, wherein the spacer comprises an injection molded plastic material.

6. A vehicle including the apparatus of claim 1.

7. A vehicle including the apparatus of claim 1, and further including a front end component adapted to pass over the bolster prior to installation of the support.

8. A vehicle including a part in need of support, comprising:
a bolster for supporting the part;
a spacer for spacing the bolster from the part; and
a clip for connecting the spacer to the bolster.

9. The vehicle of claim 8, further including an intermediate panel positioned between the component and the spacer.

10. The vehicle of claim 9, wherein the intermediate panel includes an upper surface engaging the part and a lower surface engaging the spacer.

11. The vehicle of claim 9, wherein the intermediate panel comprises a cavity for at least partially receiving the spacer.

12. The vehicle of claim 8, further including a front end component having a portion adapted for passing over the bolster during installation, the spacer extending above the bolster a first vertical distance equal to or greater than a vertical clearance between the portion of the front end component and the bolster.

13. The vehicle of claim 12, wherein the front end component comprises a headlamp assembly and the portion comprises a mounting tab.

14. A method of installing a front end component on a vehicle, comprising:
passing the front end component at least partially through a space above a bolster for supporting a part of the vehicle; and
providing a spacer on the bolster to occupy the space.

15. The method of claim 14, wherein the providing step comprises connecting the spacer to the bolster.

16. The method of claim 15, wherein the connecting step comprises clipping the spacer to the bolster.

17. The method of claim 14, further including the step of providing an intermediate panel for engaging a bumper associated with the part on an upper surface thereof and the spacer on a lower surface thereof.

18. The method of claim 14, wherein the providing step comprises providing the spacer at a fixed height relative to the bolster.

19. The method of claim 14, wherein the front end component comprises a mounting tab, and the passing step comprises passing the mounting tab through the space prior to providing the spacer.

20. The method of claim 14, wherein the providing step comprises pressing the spacer into an opening in the bolster.
